(19) United States
(12) Patent Application Publication
(10) Pub. No.: US 2026/0273659 A1
(43) Pub. Date: Sep. 17, 2026

(54) DEVICE FOR GENERATING AN AIR FLOW TO PROTECT THE PROTECTIVE GLASS OF A LASER OPTIC OF A LASER-HYBRID WELDING HEAD AND LASER-HYBRID WELDING HEAD WITH SUCH A DEVICE

(71) Applicant: Fronius International GmbH, Pettenbach (AT)

(72) Inventors: Tobias EICHBERGER, Pettenbach (AT); Helmut PFLÜGELMEIER, Pettenbach (AT); Markus SCHORN, Pettenbach (AT); Thomas HIESMAYR, Pettenbach (AT)

(73) Assignee: Fronius International GmbH, Pettenbach (AT)

(21) Appl. No.: 19/167,907

(22) PCT Filed: Oct. 24, 2024
(86) PCT No.: PCT/EP2024/080025

§ 371 Date: Sep. 23, 2025

(30) Foreign Application Priority Data
Oct. 25, 2023 (EP) 23205857.8

(51) Int. Cl. B23K 26/14; B23K 26/142

(52) U.S. Cl. CPC B23K 26/1435; B23K 26/142; B23K 26/1476

(57) ABSTRACT

A device, and a laser-hybrid welding head with the device, for generating an air flow for protecting the protective glass of a laser optic of a laser-hybrid welding head has a cyclone containing a rotationally symmetrical hollow body with a cylindrical region with a feed line for a gaseous medium for generating the air flow, the feed line being connected to inlets, and having a conical region that opens into a circular outlet. The feed line opens tangentially into a circular channel and the inlets are arranged on the inner side of the channel. The channel has a cross-section that tapers away from the mouth of the feed line, the inlets widen in a funnel-shaped manner, and a circumferential edge with an acute angle of less than 45° is at the outlet. This arrangement results in optimal air flow and optimal protection of the protective glass.

The invention relates to a device for generating an air flow for protecting the protective glass of a laser optic of a laser-hybrid welding head for machining a workpiece, having a cyclone containing a rotationally symmetrical hollow body with a cylindrical region with a feed line for a gaseous medium for generating the air flow, the feed line being connected to a plurality of inlets, and having a conical region that is designed to taper in the direction of the workpiece to be machined and opens into a circular outlet, wherein the feed line for the gaseous medium opens tangentially into an essentially circular channel and the inlets are arranged on the inner side of the channel.

The invention further relates to a laser-hybrid welding head, having a laser optic with a focusing lens for focusing a laser beam and a protective glass for protecting the focusing lens, and having an arc welding unit with an arc welding torch with a consumable welding wire.

Laser-hybrid welding heads combine a laser welding process with an arc welding process, usually with a metal-shielding gas (MSG) welding process. The advantages of both processes, the high welding speed, concentrated energy, high strength and low thermal load of the laser welding process are optimally combined with the cost-effective energy input, good gap bridgeability and the possibility of adding additional materials of the arc welding process. Laser-hybrid welding processes are characterized by high welding speed when joining thin metal sheets or maximum penetration for thicker materials. The laser-hybrid welding process is particularly suitable for automated series production in the thin metal sheet range up to approx. 3 mm, as well as for welding long sheets in the automotive industry and for shipbuilding up to approx. 10 mm thickness. Depending on the material thickness, a welding speed of up to 7 m/min can be achieved.

For example, EP 1 750 893 B1 describes a laser-hybrid welding head for welding coated metal sheets.

The laser-hybrid welding head usually has a corresponding receptacle for connection to a commercially available industrial robot. A focusing lens of the laser optic is used to focus the laser beam. A protective glass is usually located at the lower end of the focusing lens, which protects the focusing lens from contamination by splashes and welding fumes. Individual welding splashes and remaining welding fumes can reach the protective glass and adhere there. Due to the contamination, some of the laser radiation is absorbed by the protective glass, as a result of which it heats up and, in extreme cases, can be destroyed. To protect the protective glass of the laser optic, there are various concepts that essentially generate an air flow or a negative pressure on the protective glass, which reduces the likelihood of welding splashes or smoke particles reaching the surface of the protective glass and keeps the protective glass clean.

An air flow in the transverse direction to the laser beam is generated below the protective glass of the laser optic via a cross-flow nozzle (cross-jet), and the air and any dirt or smoke particles are suctioned off by a suction device arranged opposite the nozzle. A separate transverse air flow may also be used directly on the surface of the protective glass.

In the case of radial air flow, air flows via two concentrically arranged, annular inlets onto the protective glass of the laser optic. On the surface of the protective glass, the direction of the air flow reverses and is suctioned off by any transverse air flow of a cross-jet that may be provided. The flow velocity of the cross-jet is many times higher than the protective glass flow.

For example, DE 20 2005 008 564 U1 describes a device for

increasing the service life of a laser optic, wherein a device for generating a flow with a gaseous medium is provided between the protective glass and a cross-jet, which device correspondingly deflects splashes or welding fumes flying in the direction of the protective glass.

Other protective devices generate a swirling flow in the direction of the workpiece to be machined in the manner of a cyclone. For example, EP 0 732 169 A1 describes such a device for protecting the optics or the protective glass arranged in front of it from contamination.

The use of cyclones to generate an air flow to protect the protective glass of a laser processing machine is also described, for example, in DE 44 37 795 A1 , EP 3 556 504 B1 , CN 103 586 585 A, JP 2019 048331 A and JP 2006 068773 A.

A device for generating an air flow for protecting the protective glass of a laser optic of the present type has also become known from JP 2007-216290 A and KR 2023 0034627 A.

Despite such measures, it is necessary to replace the protective glass from time to time, especially with larger laser powers. The protective glass is usually replaced by a new one. However, cleaning or processing a used protective glass is also conceivable, especially if the protective glass has only been contaminated by welding fumes. With increasing laser power, the generation of welding fumes and splashes increases, which means that the protective glass has to be replaced more often and productivity decreases. In addition, an interaction between the air flow, which is used to protect the protective glass, and the strong suction effect of the cross-jet also causes undesirable turbulence above and below the cross-jet and thus a poorer protective effect for the protective glass of the laser optic. Swirls can lead to backflows in the direction of the protective glass, which is why they should be avoided.

The object of the present invention is therefore to provide a device for generating an air flow for protecting the protective glass of a laser optic of a laser-hybrid welding head for machining a workpiece, in particular with higher power, and to provide a corresponding laser-hybrid welding head, which have the longest possible service life and in which the maintenance intervals for replacing the protective glass of the laser optic can be extended. The effort and costs for the device according to the invention should not be too high. Disadvantages of known devices and methods are to be avoided or at least reduced.

The object according to the invention is achieved by an above-mentioned device for generating an air flow for protecting the protective glass of a laser optic of a laser-hybrid welding head for machining a workpiece, wherein the channel has a cross-section that tapers away from the mouth of the feed line, the inlets are designed to widen in a funnel-shaped manner, and a circumferential edge with an acute angle of less than 45° is provided at the outlet of the rotationally symmetrical hollow body of the cyclone. Due to the special introduction of the gaseous medium into the cyclone, an optimal air flow is achieved, which discharges particles outwards in the radial direction. In contrast to axially and radially directed air flows, which tend to behave unsteadily, the device according to the invention results in a uniform pressure distribution and high stability due to the uniform inflow of the gaseous medium over the circumference of the cyclone. Due to the fact that the essentially circular channel has a cross-section that tapers away from the mouth of the feed line, an even more uniform inflow of the gaseous medium can be achieved. The flow profile can also be influenced by the funnel-shaped widening of the inlets. The direction of flow of the gaseous medium can be influenced by asymmetrical design of the funnel-shaped widening of the inlets. The “sharp” edge, so to speak a tear-off edge, provided at the outlet of the rotationally symmetrical hollow body of the cyclone ensures that the air sucked in, in particular by a cross-jet, and the vortex flow downwards in the same direction, in particular into the opening of the cross-jet. Even if the design effort is somewhat higher, in particular in the region of the inflow of the gaseous medium on the upper side of the rotationally symmetrical hollow body of the cyclone, the device can be produced relatively simply and cost-effectively with corresponding production methods. In contrast to conventional devices for protecting the protective glass against impurities, a proportional relationship between the amount of gaseous medium or air and the cleaning effect can be observed in The inlets may be arranged at constant angular distances from one another. This regular division of the inlets is particularly suitable if the channel is designed in a tapered manner.

According to a further feature of the invention, the inlets may also be arranged at increasing angular distances from one another away from the mouth of the feed line. As a result of this measure, together with the design of the cross-section of the channel and the design of the inlets, a particularly uniform inflow of the gaseous medium into the cyclone can be achieved.

If the inlets are separated from one another by guide vanes, the air flow to the inlets can be further improved or supported.

Depending on the design of the essentially circular channel and the angular distances between the inlets, the guide vanes between the inlets may be identical or else be designed with a different outer contour. All of these features contribute to an optimal even distribution of air flow within the rotationally symmetrical hollow body of the cyclone.

According to a further feature of the invention, the guide vanes have an outer contour in the form of an airfoil and are designed in a curved manner. As a result, the gaseous medium flows optimally over the surfaces of the airfoil shape into the respective inlets into the rotationally symmetrical hollow body of the cyclone, and the flow profile can be further optimized.

In general, the gaseous medium is formed by compressed air, which is usually available and cheap anyway. For certain applications, however, it is also conceivable to add or use certain gases instead of air.

At least eight inlets are provided for an optimal distribution of the flow over the circumference of the cyclone.

If a generally known cross-flow nozzle (cross-jet) with a suction device that is oppositely arranged, is arranged below the outlet of the rotationally symmetrical hollow body, any particles separated by the cyclone can be optimally removed. The cross-flow nozzle may be formed, for example, by a Lavall nozzle. As a result, the separated particles do not reach the welding point. Particularly in the case of higher laser powers, the arrangement of a cross-flow nozzle is mandatory. With lower laser powers, this can also be dispensed with.

For optimal functioning of the device according to the invention, a distance of preferably 5 mm to 80 mm is provided between the outlet of the rotationally symmetrical hollow body of the cyclone and the cross-flow nozzle. As a result, an optimal interaction between the cyclone and the cross-flow is achieved.

The rotationally symmetrical hollow body of the cyclone usually has a height between 30 mm and 300 mm. A certain minimum height is necessary for proper functioning of the cyclone. The cylindrical region of the rotationally symmetrical hollow body has a diameter between 20 mm and 60 mm. The inclination of the conical region of the rotationally symmetrical hollow body of the cyclone is ideally between 5° and 45°. The diameter of the outlet of the rotationally symmetrical hollow body of the cyclone is between 10 mm and 40 mm.

The rotationally symmetrical hollow body is preferably produced together with the feed line, the circular channel and the inlets in a 3D printing process. This results in relatively low production costs. Advantageously, the device according to the invention may be produced in one piece and without complex mechanical elements.

The rotationally symmetrical hollow body, produced together with the feed line, the circular channel and the inlets may be made of metal, in particular aluminum or an aluminum alloy, or else of plastic.

The invention is also achieved by an above-mentioned laser-hybrid welding head, having a laser optic with a focusing lens for focusing a laser beam and a protective glass for protecting the focusing lens, and having an arc welding unit with an arc welding torch, having a consumable welding wire, in which a device described above is arranged for protecting the protective glass of the laser optic. As a result, the service life of the laser-hybrid welding head and thus the productivity can be increased. With regard to the further achievable advantages, reference is made to the above description of the device for generating an air flow for protecting the protective glass of the laser optic of the laser-hybrid welding head. The present invention may, of course, also be applied to pure laser welding heads without arc welding torches.

The invention is explained in more detail with reference to the attached drawings. In the drawings:

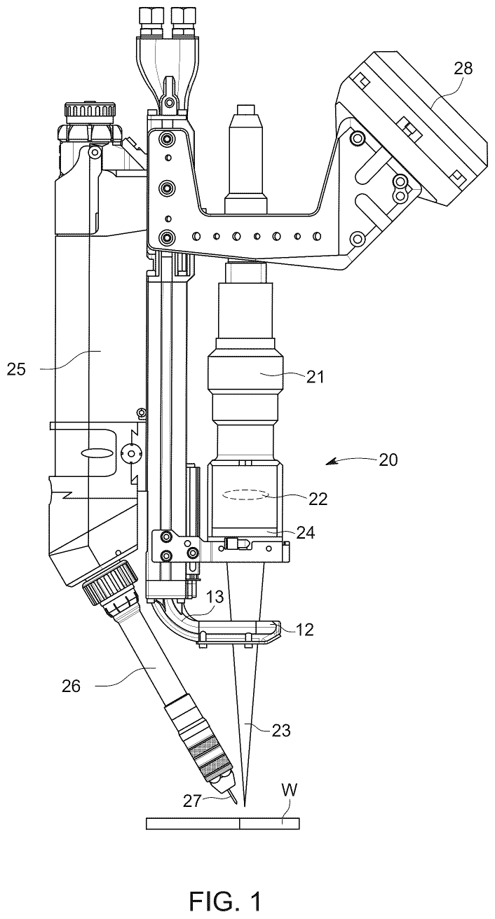

FIG. 1 shows a schematic view of a laser-hybrid welding head according to the prior art;

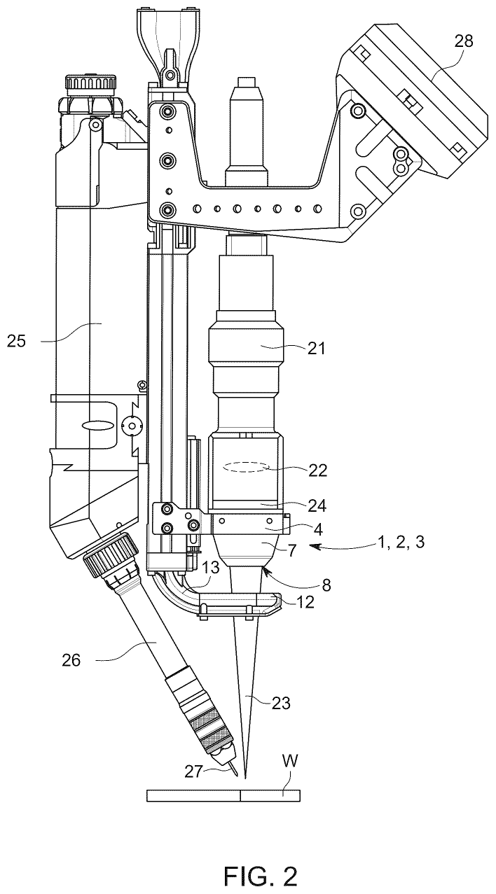

FIG. 2 shows a schematic view of a laser-hybrid welding head with a device for generating an air flow to protect the protective glass of the laser optic of the laser-hybrid welding head;

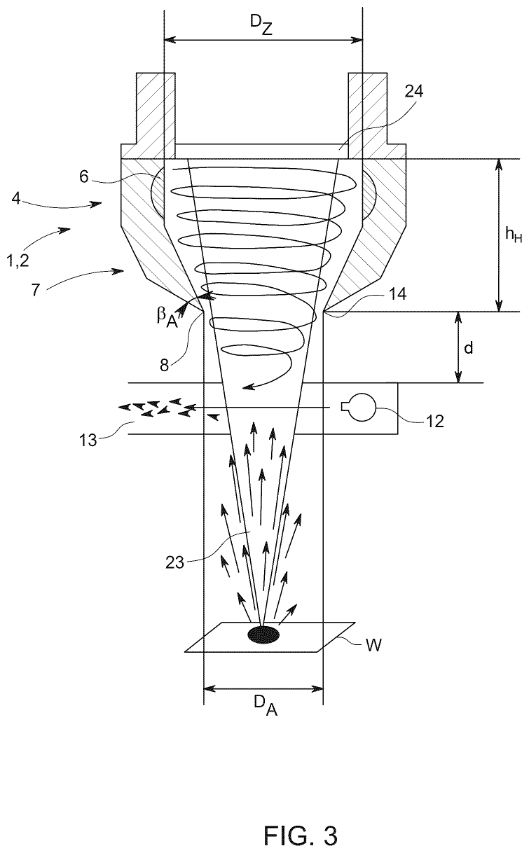

FIG. 3 shows a schematic sectional view through an embodiment of a device according to the invention for generating an air flow for protecting the protective glass of a laser optic of a laser-hybrid welding head;

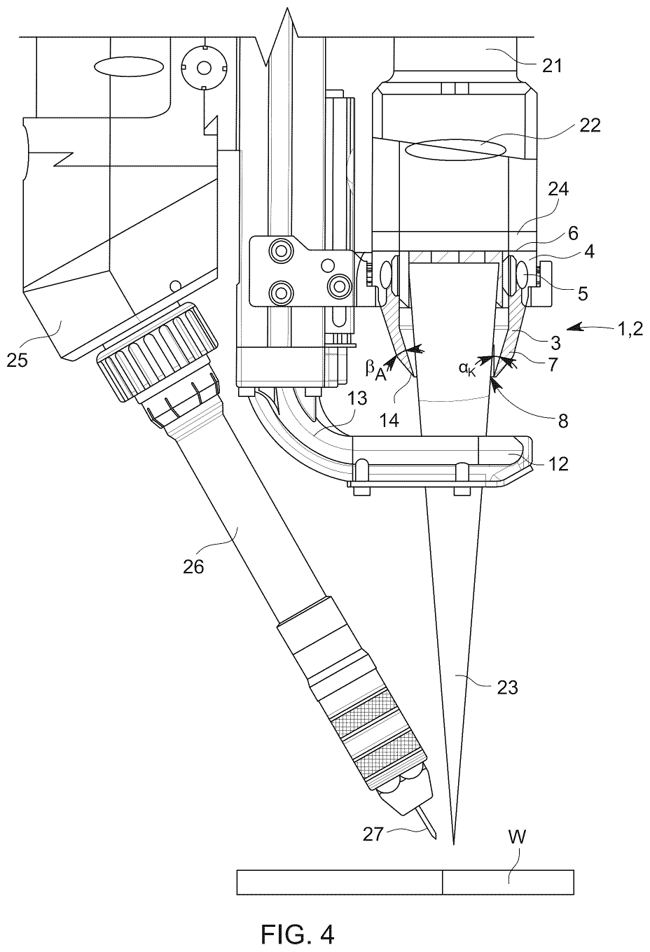

FIG. 4 shows a perspective, partially sectional view of an embodiment of a device according to the invention;

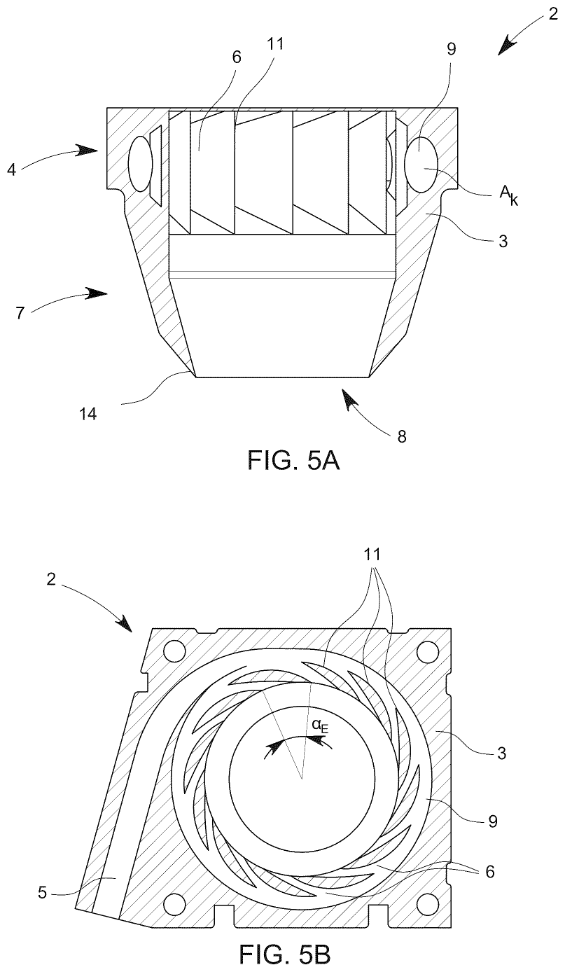

FIGS. 5A and 5B show a vertical and horizontal sectional view through a first embodiment of the device according to the invention for generating an air flow;

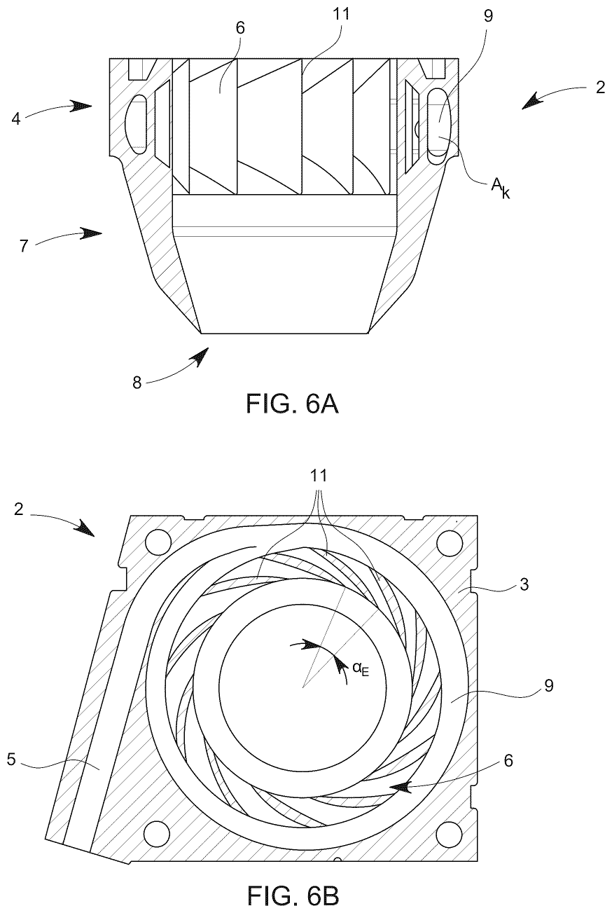

FIGS. 6A and 6B show a vertical and horizontal sectional view through a second embodiment of the device according to the invention for generating an air flow; and

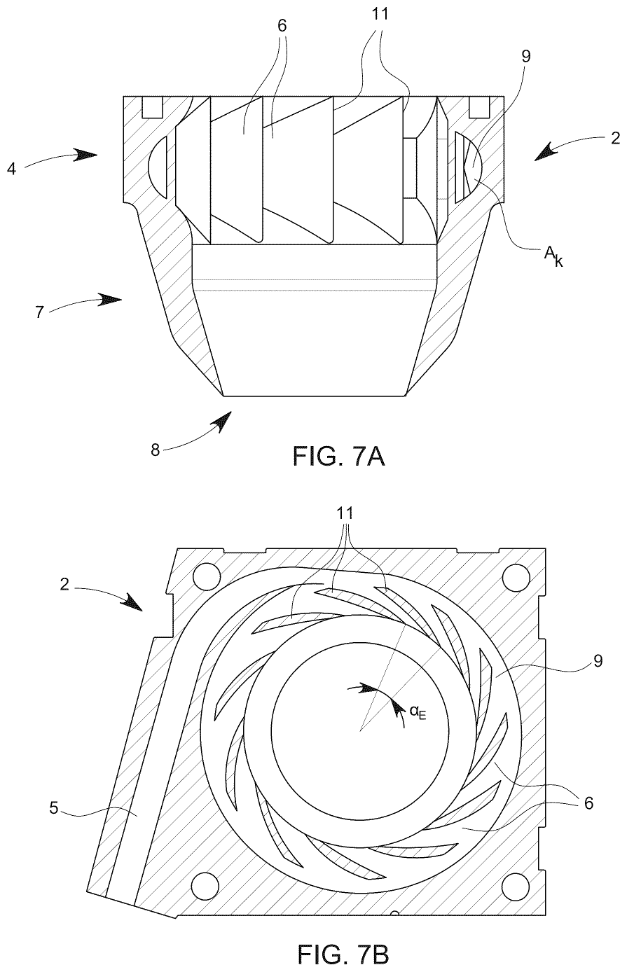

FIGS. 7A and 7B show a vertical and horizontal sectional view through a third embodiment of the device according to the invention for generating an air flow.

FIG. 1 shows a schematic view of a laser-hybrid welding head 20 according to the prior art. The laser-hybrid welding head 20 combines a laser welding process with an arc welding process. The laser beam 23 is generated in laser optic 21 and bundled in a focusing lens 22. A protective glass 24 is provided to protect the focusing lens 22 from welding splashes and welding fumes. Arranged next to the laser optic 21 is an arc welding unit 25 with an arc welding torch 26, via which a consumable welding wire 27 is fed to the welding point on the workpiece W to be machined. Laser-hybrid welding heads 20 are characterized by high welding speed when joining thin metal sheets or maximum penetration for thicker materials and are particularly suitable for automated series production, for example in the automotive industry and in shipbuilding. Accordingly, the laser-hybrid welding head 20 has a corresponding device 28 for attachment to a robot arm of a welding robot (not shown). To protect the protective glass 24 of the laser optic 21 from welding splashes or welding fumes, a cross-flow nozzle (cross-jet) 12 and an opposite suction device 13 may be located between the protective glass 24 and the welding point on the workpiece W. In this case, an air flow is generated in a direction transverse to the laser beam 23 at very high speed, preferably supersonic speed, as a result of which welding splashes can be suctioned off via the suction device 13. As a result, the welding point on the workpiece, but also the region between the cross-flow nozzle 12 and the protective glass 24 of the laser optic 21, remains free of impurities and welding fumes. Nevertheless, particularly in the case of high-power laser-hybrid welding heads 20, impurities pass to the protective glass 24 from time to time, which is why the latter must be changed at certain time intervals. The aim is to achieve the longest possible maintenance intervals and the longest possible welding times and thus high productivity.

FIG. 2 shows a schematic view of a laser-hybrid welding head 20 with a device 1 for generating an air flow to protect the protective glass 24 of the laser optic 21 of the laser-hybrid welding head 20. The device 1 for generating an air flow for protecting the protective glass 24 of the laser optic 21 of the laser-hybrid welding head 20 includes a cyclone 2 (centrifugal force separator) with a rotationally symmetrical hollow body 3 with a cylindrical region 4 with a feed line 5 for a gaseous medium for generating the air flow, the feed line 5 being connected to a plurality of inlets 6, and having a conical region 7 that is designed to taper in the direction of the workpiece W to be machined and opens into a circular outlet 8 (see also FIGS. 3 and 4).

FIG. 3 shows a schematic sectional view through an embodiment of a device 1 according to the invention for generating an air flow for protecting the protective glass 24 of a laser optic 21 of a laser-hybrid welding head 20. In order to achieve optimal flow conditions within the cyclone 2, the feed line 5 for the gaseous medium opens tangentially into an essentially circular channel 9, and the inlets 6 are arranged on the inner side of the channel 9. This design of the inlet region of cyclone 2 can be seen better with reference to the embodiment variants according to FIGS. 5A, 5B, 6A, 6B and 7A and 7B.

FIG. 4 shows a perspective, partially sectioned view of an embodiment of a device 1 according to the invention. The cyclone 2 includes a rotationally symmetrical hollow body 3 with a cylindrical region 4 with a feed line 5 for the gaseous medium for generating the air flow, the feed line 5 being connected to a plurality of inlets 6. Downwards, the rotationally symmetrical hollow body 3 is adjoined by a conical region 7 in the direction of the workpiece W to be machined, which opens into a circular outlet 8. The narrowing in the conical region 7 of the rotationally symmetrical hollow body 3 results in an acceleration of the air flow in the axial direction, which additionally counteracts the penetration of contamination. Preferably, several, in particular at least eight, inlets 6 are arranged. The rotationally symmetrical hollow body 3 of cyclone 2 usually has a height ha between 30 mm and 300 mm. The cylindrical region 4 of the rotationally symmetrical hollow body 3 has a diameter D_{z} between 20 mm and 60 mm. The inclination α_{K} of the conical region 7 of the rotationally symmetrical hollow body 3 of the cyclone 2 is ideally between 5° and 45°. The diameter D_{A} of the outlet 8 of the rotationally symmetrical hollow body 3 of the cyclone 2 is between 10 mm and 40 mm. The distance d between the outlet 8 and a cross-flow nozzle 12 is ideally between 5 mm and 80 mm. At the outlet 8 of the rotationally symmetrical hollow body 3 of the cyclone 2, there is a circumferential edge 14 with an acute angle β_{A}<45°.

The control of the air quantity for cyclone 2 and possibly the cross-flow nozzle 12 preferably takes place via corresponding valves, for example solenoid valves (not shown).

FIG. 5A shows a vertical sectional view through a first embodiment of the device 1 according to the invention for generating an air flow. FIG. 5B shows a horizontal sectional view through the device 1 at the level of the cylindrical region 4 of the rotationally symmetrical hollow body 3. The feed line 5 for the gaseous medium opens tangentially into an essentially circular channel 9. In this embodiment, the channel 9 has a cross-section A_{K} that tapers away from the mouth of the feed line 5. Inlets 6 are separated from one another by guide vanes 11, which have an outer contour in the form of an airfoil and are designed in a curved manner. In this variant, the guide vanes 11 are designed with different outer contours between the inlets 6. The angular distances α_{E} between the inlets 6 or guide vanes 11 are constant in this embodiment. As can be seen in FIG. 5A, the inlets 5 are designed to be widened in a funnel-shaped manner. The construction of the channel 9 and the inlets 6 and guide vanes 11 arranged between them allows an optimal pressure distribution over the circumference of the rotationally symmetrical hollow body 3 of the cyclone 2. As a result, turbulence, which could lead to backflows in the direction of the protective glass 24 of the laser optic 21, is avoided or minimized.

FIGS. 6A and 6B show a vertical and horizontal sectional view through a second embodiment of the device 1 according to the invention for generating an air flow. In this embodiment, the channel 9 has a cross-section A_{K} that tapers away from the mouth of the feed line 5 again. Inlets 6 are separated from one another by guide vanes 11, which are identical here, i.e., are designed with the same outer contour. In this embodiment, the angular distances α_{E} between the inlets 6 or guide vanes 11 increase away from the mouth of the feed line (5).

FIGS. 7A and 7B show a vertical and horizontal sectional view through a third embodiment of the device 1 according to the invention for generating an air flow. In this embodiment, the channel 9 has a constant cross-section A_{K}. The inlets 6 are separated from one another by guide vanes 11, which are designed identically. The angular distances α_{E} between the inlets 6 or guide vanes 11 increase away from the mouth of the feed line 5.

In addition to the embodiment variants of the inflow region of cyclone 2 shown in FIGS. 5A, 5B, 6A, 6B and 7A and 7B, further combination possibilities are also possible. The aim is a particularly optimal air flow due to the uniform inflow of the gaseous medium over the circumference of cyclone 2, resulting in a uniform pressure distribution and high stability. As a result, the protective glass 24 of the laser optic 21 can be protected particularly well against welding splashes and welding fumes, even at high outputs, and high productivity can be achieved.

1. A device (1) for generating an air flow for protecting the protective glass (24) of a laser optic (21) of a laser-hybrid welding head (20) for machining a workpiece (W), having a cyclone (2) containing a rotationally symmetrical hollow body (3) with a cylindrical region (4) with a feed line (5) for a gaseous medium for generating the air flow, the feed line (5) being connected to a plurality of inlets (6), and having a conical region (7) that is designed to taper in the direction of the workpiece (W) to be machined and opens into a circular outlet (8), wherein the feed line (5) for the gaseous medium opens tangentially into an essentially circular channel (9) and the inlets (6) are arranged on the inner side of the channel (9), wherein the channel (9) has a cross-section (AK) that tapers away from the mouth of the feed line (5), the inlets (6) are designed to widen in a funnel-shaped manner, a circumferential edge (14) with an acute angle (β_{A}) of less than 45° is provided at the outlet (8) of the rotationally symmetrical hollow body (3) of the cyclone (2), and a cross-flow nozzle (12) with a suction device (13) that is oppositely arranged, is arranged below the outlet (8) of the rotationally symmetrical hollow body (3).

2. The device (1) according to claim 1, wherein the inlets (6) are arranged at constant angular distances (α_{E}) from one another.

3. The device (1) according to claim 1, wherein the inlets (6) are arranged at increasing angular distances (α_{E}) from one another away from the mouth of the feed line (5).

4. The device (1) according to claim 1, wherein the inlets (6) are separated from one another by guide vanes (11).

5. The device (1) according to claim 4, wherein the guide vanes (11) are designed identically between the inlets (6).

6. The device (1) according to claim 4, wherein the guide vanes (11) are designed with different outer contours between the inlets (6).

7. The device (1) according to claim 4, wherein the guide vanes (11) are designed in a curved manner.

8. (canceled)

9. The device (1) according to claim 1, wherein a distance (d) between 5 mm and 80 mm is provided between the outlet (8) of the rotationally symmetrical hollow body (3) of the cyclone (2) and the cross-flow nozzle (12).

10. The device (1) according to claim 1, wherein the rotationally symmetrical hollow body (3) is produced together with the feed line the circular channel (9) and the inlets (6) in a 3D printing process.

11. A laser-hybrid welding head (20), having a laser optic (21) with a focusing lens (22) for focusing a laser beam (23) and a protective glass (24) for protecting the focusing lens (22), and having an arc welding unit (25) with an arc welding torch (26) with a consumable welding wire (27), wherein the device (1) according to claim 1 is arranged for protecting the protective glass (24) of the laser optic (21).
